(19) United States
(12) Patent Application Publication
(10) Pub. No.: US 2004/0007980 A1
(43) Pub. Date: Jan. 15, 2004

(54) Tubular LED lamp

(75) Inventor: Yoshihiko Shibata, Tokyo (JP)

Correspondence Address: ARENT FOX KINTNER PLOTKIN & KAHN, PLLC, Suite 400, 1050 Connecticut Avenue, N.W., Washington, DC, 20036-5339, US

(73) Assignees: HAKUYO DENKYUU KABUSHIKI KAISHA; FUSO DENKI KOUGYOU KABUSHIKI KAISHA; METRO DENKI KOUGYOU KABUSHIKI KAISHA

(21) Appl. No.: 10/190,474

(22) Filed: Jul. 9, 2002

(51) Int. Cl. H01J 17/16

(52) U.S. Cl. 313/634

(57) ABSTRACT

Since electrodes need to be subject to preheating before lighting in a fluorescent lamp, a preheating device such as a glow starter is necessary and it takes a long time to complete lighting. Further, in a fluorescent lamp of a cold-cathode type, which is lit up by applying high voltage between electrodes without preheating, although lighting is instantly carried out, a large ballast having a chalk coil and the like is necessary, thereby increasing the cost. Besides, since it is necessary to fill mercury steam and Argon gas in an arc tube, the material of the arc tube is limited to glass having high resistance to pressure and high hermeticity. An LED chain body 2 formed by connecting a plurality of LED lamps 3 via flexible members 4 is inserted into a transparent or translucent tube 1.

### BACKGROUND OF THE DEVICE

1. Field of the Device

The present device relates to a tubular LED lamp using LED lamps or LED chips as a light source.

2. Description of the Related Art

Conventionally, as a tubular lamp, so-called fluorescent lamps have been known, in which mercury vapor is filled in a glass tube, ultraviolet rays obtained by arc discharge using electrodes in the mercury vapor are transformed into visible radiation by using a fluorescent material applied to an inner surface of the tube, the electrodes being provided in the tube, and the visible radiation is used as illumination light.

### SUMMARY OF THE DEVICE

In such fluorescent lamps, electrodes generally need to be subjected to preheating before lighting. Thus, a preheating device such as a glow starter is necessary, so that it takes a long time to complete lighting. Further, as to a fluorescent lamp of a cold-cathode starting type that is lit up by applying high voltage between electrodes without preheating, although lighting is instantly carried out, a large ballast having a chalk coil and the like is necessary and the cost is raised.

Moreover, in these fluorescent lamps, it is necessary to fill mercury vapor into a tube with a low pressure. Thus, the material of the tube is limited to glass having high resistance to pressure and high hermeticity. Moreover, since light is generated by discharge between electrodes in fluorescent lamps, a distance between the electrodes is limited and the tube cannot be formed with a predetermined length or more.

Thus, in view of the above-described problems, the present device has as its object the provision of a tubular LED lamp which can be instantly lit up without the necessity for a preheating device or a ballast, the range of selection is wide for a material of a tube, and the tube can be formed with a desired length.

In order to solve the above-described problems, the present device is characterized in that an LED chain body is inserted into a transparent or translucent tube, the LED chain body being formed by connecting a plurality of LED lamps or LED chips via flexible members.

With this configuration, since a light-emitting diode (LED) in the tube can be lit up by using a direct-current power supply, the diode can be instantly lit up without the necessity for a preheating device or a ballast. Further, since the LED is used as a light source, heat loss is lower, the same amount of light can be obtained with lower power, and the life is longer as compared with a fluorescent lamp. Moreover, since it is not necessary to fill mercury vapor in the tube, a material of the tube can be selected from a variety of materials. For example, a flexible material is selected so as to form a tubular LED lamp which can be transformed freely. Besides, the length of the LED chain body inserted into the tube is changed in accordance with the length of the tube, so that the tubular LED lamp can be formed entirely with a desired length.

Additionally, in the present device, at least one of a fluorescent material, a phosphorescence material, a diffusion material for diffusing light, and a reflective material for reflecting light may be applied to the tube, or the tube may be made of a material in which at least one of a fluorescent material, a phosphorescence material, a diffusion material for diffusing light, and a reflective material for reflecting light is mixed.

With this configuration, light emitted by the LED is radiated secondarily by a fluorescent material or a phosphorescence material, which is mixed or applied in the tube, or the light is diffused or reflected by a diffusion material or a reflective material. Thus, lighting can be carried out over the surface of the tube so as to obtain light similar to that of a fluorescent lamp.

### BRIEF DESCRIPTION OF THE DRAWINGS

FIG. 1 is a diagram showing the configuration of one embodiment of the present device; and

FIG. 2 is a diagram showing the configuration of an LED light source for lighting.

### DETAILED DESCRIPTION OF PREFERRED EMBODIMENTS

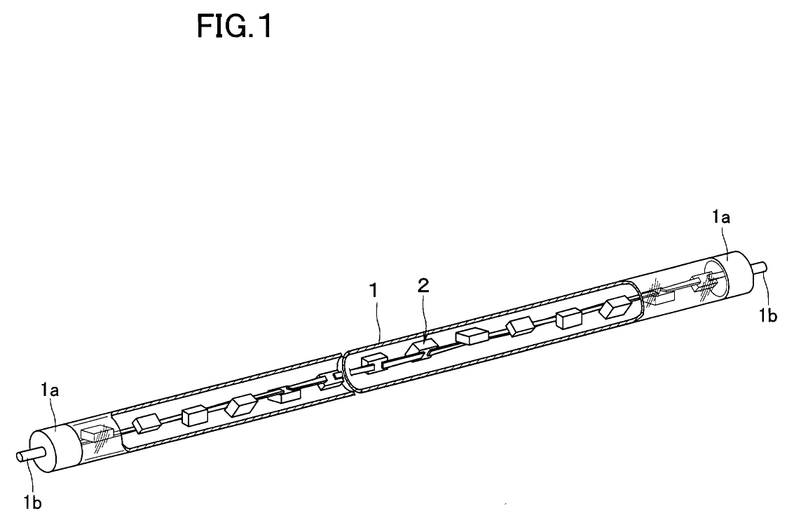

Referring to FIG. 1, reference numeral 1 denotes a tube made of transparent acrylic resin. Bases 1a used for a fluorescent lamp of a cold-cathode starting type are provided on both ends of the tube 1. The bases 1a have pins 1b as terminals, respectively. The LED chain body 2 is inserted into the tube, and both ends of the LED chain body 2 are respectively connected to the pins 1b in the tube.

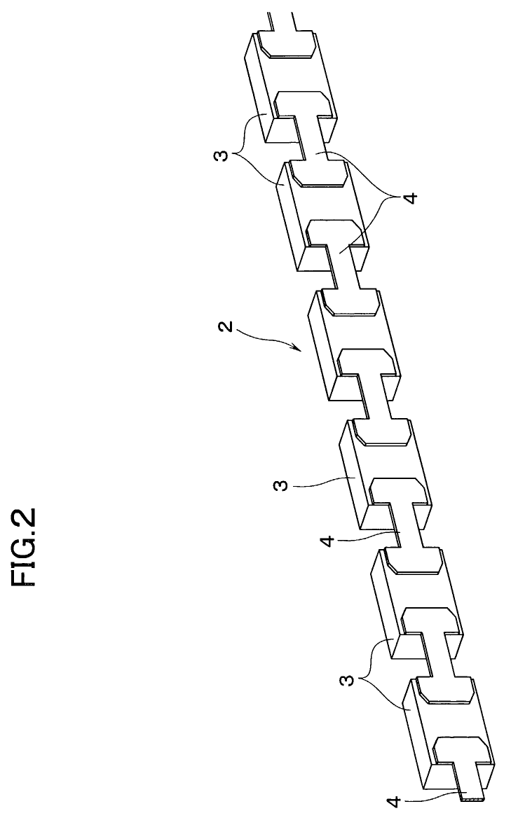

As shown in FIG. 2, the LED chain body 2 is configured such that a plurality of ultraviolet emission LED lamps 3, which are formed by embedding ultraviolet emitting LED chips in transparent bodies, are connected in series via flexible members 4, which are composed of thin metallic plates (e.g., copper plates with a thickness of 0.1 mm). Referring to FIG. 1, in the LED chain body 2, the flexible members 4 composed of plate members are twisted so as to slightly shift distribution of light between the adjacent ultraviolet emission LED lamps 3. Here, the LED chain body 2 is formed by connecting the LED lamps. The LED chain body 2 may be formed by connecting LED chips instead of the LED lamps directly via the flexible members 4.

A fluorescent material (e.g., potassium halophosphate) is applied over the inner surface of the tube 1. The fluorescent material absorbs ultraviolet rays emitted from the ultraviolet emission LED lamps 3 and radiates visible radiation. Besides, since the emission effectiveness of the ultraviolet emission LED lamps 3 is inversely proportional to the square of the distance from the ultraviolet emission LED lamps 3, it is desirable to set the diameter (e.g., 5 mm) of the tube 1 nearly at the minimum diameter permitting the insertion of the LED chain body 2 and to minimize the distance between the ultraviolet emission LED lamps 3 and the tube 1 so as to improve emission efficiency.

In the above-described embodiment, the fluorescent material is applied over the inner surface of the tube 1. The fluorescent material may be applied on an outer surface, or instead of applying the fluorescent material, the tube 1 may be made of acrylic resin, in which a fluorescent material is mixed. Instead of a fluorescent material, a phosphorescence material, a diffusion material for diffusing light, and a reflective material for reflecting light may be applied or mixed, or two or more may be selected for application or mixing from the above materials.

Additionally, the above-described embodiment described the tubular LED lamp using acrylic resin as a material of the tube 1. Instead of acrylic resin, a transparent or translucent resin (e.g., polyvinyl chloride) with flexibility may be used. In this case, since the tube can be freely transformed, it is possible to manufacture a light-emitting structure (e.g., character goods) having a desired shape.

[Advantages of the Device]

As described above, in the present device, a light-emitting diode (LED) can be lit up by using a direct-current power supply. Thus, it is possible to eliminate the necessity for a preheating device or a ballast, the cost is lower than a fluorescent lamp, and quick lighting is possible. Further, since the LED is used as a light source, heat loss is lower, the same amount of light can be obtained with lower power, and the life is longer as compared with a fluorescent lamp. Furthermore, since it is not necessary to fill mercury vapor and an Argon gas in a tube, a material of the tube can be selected from a variety of materials. A flexible material is selected so as to form a tubular LED lamp which can be transformed freely. Besides, the length of an LED chain body inserted into the tube is changed in accordance with the length of the tube, so that the tubular LED lamp can be formed entirely with a desired length. Moreover, light emitted by the LED is radiated secondarily by a fluorescent material or a phosphorescence material, which is mixed or applied in the tube, or the light is diffused or reflected by a diffusion material or a reflective material. Thus, lighting can be performed over the surface of the tube so as to obtain light similar to that of a fluorescent lamp.

What is claimed is:

1. A tubular LED lamp, characterized in that an LED chain body is placed in a transparent or translucent tube, the LED chain body being formed by connecting a plurality of LED lamps or LED chips via flexible members.

2. The tubular LED lamp according to claim 1, characterized in that at least one of a fluorescent material, a phosphorescence material, a diffusion material for diffusing light, and a reflective material for reflecting light is applied to the tube.

3. The tubular LED lamp according to claim 1, characterized in that the tube is made of a material in which at least one of a fluorescent material, a phosphorescence material, a diffusion material for diffusing light, and a reflective material for reflecting light is mixed.
